(19) United States
(12) Patent Application Publication
(10) Pub. No.: US 2012/0130605 A1
(43) Pub. Date: May 24, 2012

(54) DEVICE FOR PREVENTING A MOTOR VEHICLE FROM BEING SET IN MOTION

(75) Inventor: Gerald KUESTLER, GAGGENAU (DE)

(73) Assignee: SCHAEFFLER TECHNOLOGIES AG & CO. KG, Herzogenaurach (DE)

(21) Appl. No.: 13/349,893

(22) Filed: Jan. 13, 2012

Related U.S. Application Data
(63) Continuation of application No. PCT/DE2010/000731, filed on Jun. 24, 2010.

(30) Foreign Application Priority Data
Jul. 13, 2009 (DE) 10 2009 032 830.0

(51) Int. Cl. G06F 7/00

(52) U.S. Cl. 701/51; 701/1

(57) ABSTRACT

A device for preventing a motor vehicle from being set in motion. The motor vehicle has a drive motor that can be connected to drive wheels in a driving connection by a drive train.

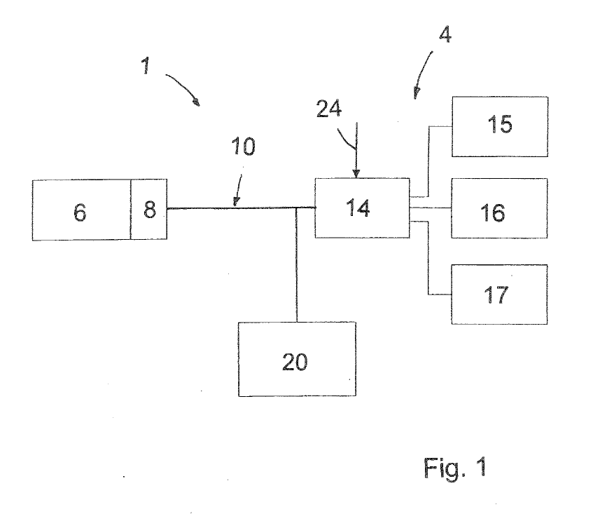

### CROSS-REFERENCE TO RELATED APPLICATIONS

This application is a continuation of PCT/DE2010/000731 filed Jun. 24, 2010, which in turn claims the priority of DE 10 2009 032 830.0 filed Jul. 13, 2009. The priority of these applications is hereby claimed and these applications are incorporated by reference herein.

### FIELD OF THE INVENTION

The invention relates to a device for preventing a motor vehicle from being set in motion if a definable criterion is met.

### BACKGROUND OF THE INVENTION

German utility model DE 296 22 607 U1 discloses an electronic immobilizer for a motor vehicle, which has a control circuit that is assigned to the power supply of the motor vehicle and a sensor device which is coupled to the control circuit. The control circuit for controlling the power supply of the motor vehicle acts on the ignition circuit of the engine ignition. German utility model DE 20 2006 018 180 U1 discloses an alcohol tester as an immobilizer which is located in the vehicle instrumentation and does not enable the power supply to the ignition by means of a fixedly installed enabling scale if legal blood alcohol limits are exceeded. German patent application DE 10 2007 047 709 A1 discloses a device for preventing a motor vehicle from being started or activated by a driver who is under the influence of alcohol. The device comprises an apparatus for determining the alcohol level and an immobilizer which prevents the vehicle from being started or activated if the alcohol content which is determined by the device exceeds a predefined threshold value. Means for bypassing or deactivating the immobilizer are additionally provided.

### SUMMARY OF THE INVENTION

The present invention relates to improving further a device that prevents a motor vehicle from being set in motion. In particular, the present invention relates to improving the device with respect to emergency situations.

Accordingly, the present invention is directed to a device for preventing a motor vehicle from being set in motion where motor vehicle comprises a drive engine which can be connected in a driving fashion to driven wheels via a drive train. The device has an immobilizer, which is activated if a predefinable criterion is met and a drive train controller. The immobilizer is connected in a controlling fashion to the drive train controller in such a way that, when the immobilizer is activated, a driving connection between the drive motor and the driven wheels continues to be interrupted, but it is possible to start the drive motor in order to maintain vehicle functions which are important for survival.

In one embodiment, the predefinable criterion is that the vehicle driver is under the influence of alcohol.

The present invention is also directed to a device for preventing a motor vehicle, which has a drive engine that can be connected in a driving fashion to driven wheels via a drive train by a vehicle driver who is under the influence of alcohol, from being set in motion. The device includes an apparatus for determining an alcohol level of the vehicle driver, a drive train controller and an immobilizer which is activated if the determined alcohol level of the vehicle driver reaches or exceeds a critical alcohol level. The immobilizer is connected in a controlling fashion to the drive train controller in such a way that, when the immobilizer is activated, a driving connection between the drive engine and the driven wheels continues to be interrupted, but it is possible for a vehicle driver who is under the influence of alcohol to start the drive engine in order to maintain vehicle functions which are important for survival. The vehicle functions which are important for survival are, for example, the heating of the passenger compartment of the vehicle. The device firstly reliably prevents drunk driving. Secondly, the starting of the drive engine ensures that, for example, at low external temperatures, the running drive engine can be used to make available sufficient energy to ensure sufficient heating of the passenger compartment of the vehicle even over a relatively long period of time.

In one embodiment, the immobilizer is connected in a controlling fashion to a transmission controller. In automatic transmissions drunk driving can be prevented, for example, by selectively locking a shiftable starting clutch and a parking lock, but nevertheless permitting the engine of the vehicle to be started.

In another embodiment, the immobilizer is connected in a controlling fashion to a shiftable clutch. In an automatic transmission with torque converter, the clutch may be a multi-function clutch. The clutch in the case of continuously variable conical-pulley transmissions can be a starting clutch.

In a further alternative, the immobilizer is connected in a controlling fashion to a shiftable starting clutch. In the case of clutch-by-wire vehicles, the activation of the clutch can be prevented by the transmission control management system. In clutch servosystems, a clutch servo, or the controller thereof, can prevent actuation of the clutch. In such cases, a parking lock or an electromechanical parking brake can also simultaneously be active in order to prevent undesired rolling away of the vehicle.

In yet another embodiment of the device, the immobilizer is connected in a controlling fashion to a parking lock. For safety reasons, when the vehicle is stationary the device should be activated. As a result, unintentional, safety-critical reactions on the part of the transmission controller can be prevented during travel.

In a further embodiment of the device, the immobilizer is connected in a controlling fashion to a transmission control device via a vehicle bus system. If information about the fact that the critical alcohol level has been reached or exceeded by the vehicle driver is present on the bus of the vehicle bus system, the engine controller can, alone or in combination with the transmission controller, prevent the motor vehicle from being started. It is therefore possible, for example, that at noncritical or normal external temperatures, starting of the drive engine is prevented by means of the engine controller, but at critical or relatively low temperatures the vehicle is prevented from being driven away by means of the transmission controller, with the result that assemblies, such as heating assemblies, which are important for survival using the running drive engine, can still be operated.

In yet a further embodiment of the device, the immobilizer is connected in a controlling fashion to a transmission actuator system, a clutch actuator system, a selector level and/or a parking lock of an automatic transmission.

In an even further embodiment of the device, the immobilizer is connected in a controlling fashion to the drive train controller in such a way that the immobilizer can be activated only when the motor vehicle is stationary. As a result, intentional, safety-critical reactions on the part of the drive train controller can be prevented during travel if, for example, the device for determining the alcohol level of the vehicle driver transmits a faulty signal.

Further advantages, features and details of the invention emerge from the following description in which various exemplary embodiments are described in detail with reference to the drawing.

### BRIEF DESCRIPTION OF THE DRAWING

The FIGURE schematically illustrates a device according to the invention.

### DETAILED DESCRIPTION OF THE INVENTION

The FIGURE illustrates in a highly simplified schematic form of a device 1 for preventing a motor vehicle from being set in motion. The motor vehicle comprises a drive engine which can be connected in a driving fashion to driven wheels via a drive train. The driving connection between the drive engine and the drive train is controlled by a drive train controller 4. The drive train controller 4 is connected in a controlling fashion to an apparatus 6 for determining an alcohol level of a vehicle driver of the motor vehicle.

The apparatus 6 is a breath alcohol measuring device which is connected to a transmission control device 14 via a bus interface 8 and an internal vehicle bus system 10. The transmission control device 14 is in turn connected in a controlling fashion to a transmission actuator system 15, a clutch actuator system 16 and a selector level as well as a parking lock 17 of an automatic transmission. The apparatus 6 and the transmission control device 14 are connected to a driver information module 20 via the vehicle bus system 10. An input variable of the transmission control device 14 is indicated by an arrow 24. The input variable is, for example, the speed of the vehicle. The input variable may also be the external temperature.

According to one essential aspect of the invention, the apparatus 6 with the breath alcohol measuring device interacts with the transmission control device 14 via the vehicle bus system 10 in such a way that, for example by selectively locking a shiftable start clutch and a parking lock, drunk driving is prevented, but nevertheless starting of the drive engine by a vehicle driver under the influence of alcohol is permitted. The breath alcohol measuring apparatus 6 either transmits a travel enable signal via the vehicle bus system 10 or a travel prevention signal if the driver is under the influence of alcohol. The transmission control device 14 receives this signal via the vehicle bus system 10 and, in the event the driver is under the influence of alcohol, initiates a corresponding measure.

The clutch advantageously remains open when the drive engine starts. Furthermore, the gears continue to be disengaged and the freedom to move the selector level of the automatic transmission out of the parked position is not given, that is to say the parking lock remains active. In this way, the drive engine can be started so that the secondary assemblies, such as the vehicle heating system, can be operated for the passenger compartment of the vehicle, but, at the same time, drunk driving is prevented. The fact that the parking lock continues to be active prevents undesired rolling away of the motor vehicle.

### LIST OF REFERENCE NUMBERS

1 Device
4 Drive Train Controller
6 Apparatus
8 Bus Interface
10 Vehicle Bus System
14 Transmission Control Device
15 Transmission Actuator System
16 Clutch Actuator System
17 Selector Lever and Parking Lock
20 Driver Information Module
24 Arrow

What is claimed:

1. A device for preventing a motor vehicle, which comprises a drive engine that can be connected in a driving fashion to driven wheels via a drive train, from being set in motion, the device comprising:
a drive train controller; and
an immobilizer, which is activated if a definable criterion is met,
wherein the immobilizer is connected in a controlling fashion to the drive train controller in such a way that, when the immobilizer is activated, a driving connection between the drive engine and the driven wheels continues to be interrupted, but the drive engine can be started in order to maintain vehicle functions which are important for survival.

2. The device as claimed in claim 1, wherein the predefinable criterion is a vehicle driver under an influence of alcohol.

3. A device for preventing a motor vehicle, which comprises a drive engine that can be connected in a driving fashion to driven wheels via a drive train by a vehicle driver that is under an influence of alcohol, from being set in motion, the device comprising:
an apparatus for determining an alcohol level of the vehicle driver;
a drive train controller; and
an immobilizer, which is activated if the alcohol level determined of the vehicle driver reaches or exceeds a critical alcohol level,
wherein the immobilizer is connected in a controlling fashion to the drive train controller in such a way that, when the immobilizer is activated, a driving connection between the drive engine and the driven wheels continues to be interrupted, but the drive engine can be started by the vehicle driver who is under the influence of alcohol in order to maintain vehicle functions which are important for survival.

4. The device as claimed in claim 3, wherein the motor vehicle has a transmission controller and the immobilizer is connected in a controlling fashion to the transmission controller.

5. The device as claimed in claim 3, wherein the motor vehicle has a shiftable clutch and the immobilizer is connected in a controlling fashion to the shiftable clutch.

6. The device as claimed in claim 3, wherein the motor vehicle has a shiftable starting clutch and the immobilizer is connected in a controlling fashion to the shiftable starting clutch.

7. The device as claimed in claim 3, wherein the motor vehicle has a parking lock and the immobilizer is connected in a controlling fashion to the parking lock.

8. The device as claimed in claim 3, wherein the motor vehicle has a transmission control device and a vehicle bus system, and the immobilizer is connected in a controlling fashion to the transmission control device via the vehicle bus system.

9. The device as claimed in claim 3, wherein the motor vehicle has a transmission actuator system and the immobilizer is connected in a controlling fashion to the transmission actuator system.

10. The device as claimed in claim 3, wherein the motor vehicle has a clutch actuator system and the immobilizer is connected in a controlling fashion to the clutch actuator system.

11. The device as claimed in claim 3, wherein the motor vehicle has an automatic transmission and the automatic transmission has a selector lever and/or a parking lock, and the immobilizer is connected in a controlling fashion to the selector lever and/or the parking lock of the automatic transmission.

12. The device as claimed in claim 3, wherein the immobilizer is connected in a controlling fashion to the drive train controller in such a way that the immobilizer can be activated only when the vehicle is stationary.

13. A vehicle, comprising:
driven wheels;
a drive train;
a drive engine that can be connected in a driving fashion to the driven wheels via the drive train; and
a device for preventing the motor vehicle from being set in motion, the device having a drive train controller and an immobilizer, which is activated if a definable criterion is met,
wherein the immobilizer is connected in a controlling fashion to the drive train controller in such a way that, when the immobilizer is activated, a driving connection between the drive engine and the driven wheels continues to be interrupted, but the drive engine can be started in order to maintain vehicle functions which are important for survival.
